(19) United States
(12) Patent Application Publication
(10) Pub. No.: US 2003/0179181 A1
(43) Pub. Date: Sep. 25, 2003

(54) Antennas for wireless computing

(76) Inventor: John W. Caldwell, Wallingford, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/395,445

(22) Filed: Mar. 24, 2003

Related U.S. Application Data
(60) Provisional application No. 60/366,600, filed on Mar. 22, 2002.

(51) Int. Cl. G09G 5/00

(52) U.S. Cl. 345/156

(57) ABSTRACT

Improved antennas for “wireless” computing are provided In accordance with certain featured embodiments, wireless communications between computers and peripherals such as keyboards, pointing devices, monitors, processors, networks, printers, and other devices, are provided. Antennas and antenna systems are adapted, for example, for use in areas, such as individual offices, conference rooms, and the like, or for larger assemblages, networks and sites. Methods of installing such antennas and methods of using them are also comprehended herby. In accordance with preferred features, inobtrusive, flat antennas are connected to personal computers via small, inconspicuous wiring. Such antennas can be placed beneath wallpaper and the like.

### FIELD OF THE INVENTION

The present invention is directed to improved antennas for “wireless” computing. In accordance with preferred embodiments, wireless communications between computers and peripherals such as keyboards, pointing devices, monitors, processors, networks, printers, and other devices, are provided. These antennas and antenna systems are adapted, for example, for use in areas, such as individual offices, conference rooms, and the like, or for larger assemblages, networks and sites. Methods of installing such antennas and methods of using them are also comprehended herby.

### BACKGROUND OF THE INVENTION

It is presently known to provide wireless access to computers on the part of keyboards, pointing devices such as mice, and the like. An exemplary system is provided by the Logitech Company under the trademark “i-Touch.” In the i-Touch system, an antenna unit is connected to the keyboard and mouse ports of a personal computer. The wire connectors from the keyboard and mouse ports are then run a distance to an electronics and antenna unit which is placed adjacent to a wireless keyboard and mouse. This antenna unit and electronics are connected via radio frequency with the keyboard and mouse. In this way, an individual can move the keyboard and the mouse without being restrained by cords. The antenna is generally intended to be short range, so as to minimize interference among adjacent offices and the like. Similar systems join processors together into a Network, connect other peripherals such as printers and monitors and otherwise find general utility.

### SUMMARY OF THE INVENTION

While cordless keyboards and cordless mouse systems using radio frequency, such as the one described above, are becoming popular, they have limitations. For example, placement of a single antenna unit so as to cover an entire office room is difficult. The ability to move throughout an office with the keyboard and mouse, for example, to access a second monitor unit for conferencing or other reasons, is generally hard to achieve. The antenna unit which is, at present, combined with the electronics, which drives it, is present in a bulky and unsightly box, which is difficult to conceal. It is also difficult to install and comes with a relatively thick, ten wire cord, which has to be dealt with. The cord is difficult to move throughout an office, save through the use of unsightly, bulky, and inconvenient patchcords. Many of the potential benefits of cordless operation are lost thereby.

The present invention provides a new organization and arrangement of antennas for wireless systems which give rise to a number of benefits. In accordance with certain embodiments of this invention, the antenna function is spatially separated from the electronics function. The antenna is adapted so as to be easily placed in a number of different locations in a room. Indeed, through the use of the present invention, multiple antennas can be connected to a single electronics set so that complete room coverage may be attained conveniently and economically. In addition to the foregoing, it is also possible to hide the antennas for such systems in very inconspicuous, but yet convenient ways so as to improve the aesthetics of the system while retaining its full functionality.

Accordingly, electronics for antenna units are provided at a location either within a computer case, such as by way of a card, or adjacent to the keyboard and mouse or other connection ports found on the computer case. The actual antenna, however, is not a part of the electronics package. Rather, a remote antenna is provided, which is connected to the electronics unit typically through a pair of connectors formed of relative small dimension wire or cable. Preferably, the antenna and cable are “flat.” Since it is no longer necessary to make connection to the actual antenna using a bulky, ten wire connector, as is presently required by the exemplary Logitech System, simplification and reduction of size can be attained.

In this way, an antenna can be placed in many difference locations through a room. For example, it can be applied to the reverse of a picture. The connecting cable, being small and unobtrusive, facilitates this. In a particularly preferred embodiment, the antenna and a portion of the wire leading to it are actually installed underneath wallpaper or wall coverings in the room in which the installation is to take place. The remaining part of the electronic lead to the electronics package can then be conducted in an unobtrusive way, such as underneath carpeting, around the baseboard, or the like, so that the whole of the antenna and conducting lead cannot be seen. They still function in their intended way since the organic materials of a wall covering do not interfere with radio frequency energy.

It is also a feature of the present invention to provide multiple antennas connected to the same electronics unit. Thus, a series of connectors can be provided in the electronics unit (which is either within the personal computer or is relatively adjacent to the keyboard and mouse connectors thereof. Individual leads run to individual, unobtrusive, preferably flat, antennas. In this way, a plurality of antennas may be dispersed around a room or other space. As a result of this, the keyboard and mouse can be used anywhere in the room and yet connect with the same computer. A plurality of monitors may be dispersed around the room to facilitate the employment of a single computer in different environments or diverse locations.

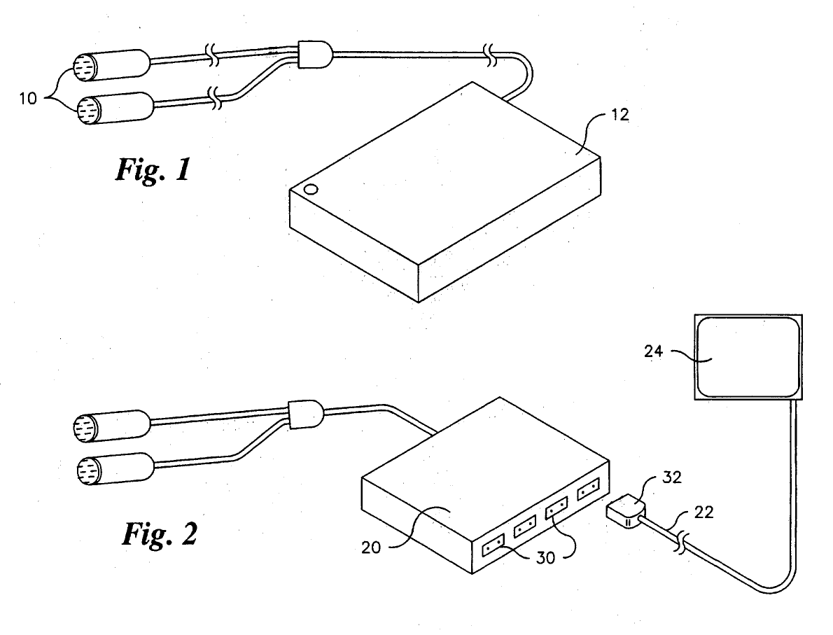

FIG. 1 depicts a prior, Logitech i-Touch antenna and electronics unit. Connectors for mouse and keyboard plugs on a conventional personal computer are depicted, 10, as is the combined antenna and electronics unit, 12. The bulkiness of the combined antenna and electronics unit is apparent.

FIG. 2 depicts one system in accordance with the present invention. An electronics unit with connectors and mouse and keyboards outlets of a personal computer is provided in such a way that the electronics unit, 20, can be either “hung from” the PC or located adjacent to it and out of sight. An antenna connector pair, 22, runs to an antenna unit, 24, which can be mounted remote from the PC, such as beneath wallpaper, attached to a planter, underneath a desk surface, in the ceiling, or anywhere else.

A modification wherein a plurality of antenna units may be connected to a single electronics unit is preferred for some situations. Connector locations, 30 are shown on an electronics unit, 20 where individual antenna connectors, 32 may be inserted. In this way, two, three, or more antennas may be dispersed within a space to provide coverage of that space. Keyboard and mouse functions may be used over a much wider area than is presently possible. At the same time, the antennas may be inconspicuously located, improving the aesthetics of the space. While not shown, it is also possible to link antennas in series for same applications or to use parallel leads leading to a plurality of antennas.

It is also possible to retrofit a space for antenna installation. In this way, small portions of wallpaper may be steamed open to permit the insertion of antenna wire and the antenna itself. The wall covering can then be closed over the antenna without affecting the aesthetics. The antenna and antenna lead should be sufficiently inexpensive so as to permit the abandonment of the antenna should the room ever be vacated.

While certain embodiments of the present invention have been described in some detail, persons of ordinary skill in the art will readily appreciate that other variations and embodiments thereof may also be employed to good success.

What is claimed is:

1. A wireless computer keyboard or mouse communications device comprising:
an electronics unit connected to at least one of the keyboard and mouse interfaces of a digital computer, the electronics unit being adjacent to said interface; and
a substantially flat antenna remote from the interface and in electrical communication with the electronics unit.

2. The device of claim 1 wherein the electronics unit is connected to each of the keyboard and mouse interfaces of the computer.

3. The device of claim 1 wherein the electronics unit is connected to each of the keyboard and mouse interfaces of the computer and is located within a case for the computer.

4. The device of claim 1 wherein the electronics unit is connected to each of the keyboard and mouse interfaces of the computer externally to a case thereupon.

5. The device of claim 4 wherein the electronics unit is hung from the computer.

6. The device of claim 1 wherein a plurality of antennas is in electrical communication with the electronics unit.

7. The device of claim 1 wherein the antenna is disposed upon a flat support.

8. An antenna system comprising a plurality of substantially flat antennas disposed about a space, each of the antennas being in electrical communication with an electronics unit connected to at least one of the keyboard and mouse interfaces of a digital computer; the electronics unit being adjacent to the interface; the plurality of antennas being remote from the interface.

9 The antenna system of claim 8 wherein at least one antenna is surmounted by a wall covering.

10. The antenna system of claim 8 wherein substantially all of the antennas are hidden from view.

11. The antenna system of claim 8 forming substantially complete, wireless keyboard or mouse coverage throughout a space.

12. A method of installing an antenna in electrical communication with a computer comprising providing a substantially flat looped wire on a substantially flat support; and placing the looped wire and support beneath a wall covering.
